(19) United States
(12) Patent Application Publication
(10) Pub. No.: US 2020/0278071 A1
(43) Pub. Date: Sep. 3, 2020

(54) FRAC MANIFOLD SUPPORT SYSTEM

(71) Applicant: Payzone Completion Services, LLC, Oklahoma City, OK (US)

(72) Inventors: David Droke, Elk City, OK (US); Billy R. Riggs, Woodward, OK (US)

(73) Assignee: Payzone Completion Services, LLC

(21) Appl. No.: 16/803,676

(22) Filed: Feb. 27, 2020

Related U.S. Application Data
(60) Provisional application No. 62/811,965, filed on Feb. 28, 2019.

(51) Int. Cl. F16M 7/00; F16M 5/00

(52) U.S. Cl. CPC F16M 7/00; E21B 43/26; F16M 5/00

(57) ABSTRACT

A frac manifold support system includes a platform having a slider plate disposed thereon. The system also including a secure container unit secured relative to the slider plate for supporting a studded cross or studded block. The system further includes a selectively secure container unit slidably disposed on the slider plate for supporting a studded cross or studded block and a driving device for moving the selectively secure container unit towards and away from the secure container unit. A method for accessing various parts of the frac manifold support system includes the step of unsecuring a spacer spool from a studded block or studded cross to gain access to a desired area for maintenance. The method also includes the step of creating a first section of the frac manifold support system and a second section of the frac manifold support system. Further, the method includes the step of separating the second section of the frac manifold support system from the first section of the frac manifold support system to allow access to the desired area.

### CROSS-REFERENCE TO RELATED APPLICATIONS

The present application is a conversion of U.S. Provisional application having U.S. Ser. No. 62/811,965, filed Feb. 28, 2019, which claims the benefit under 35 U.S.C. 119(e), the disclosures of which are hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to a frac manifold support system that permits more efficient maintenance of various parts of a frac manifold.

### 2. Description of the Related Art

A frac manifold is an arrangement of flow fittings and valves installed downstream of the frac pump output header and upstream of each frac tree. In some instances, the frac tree is incorporated in the frac manifold and the frac manifold is located between the frac pump output and a relative well head. The flow fittings and valves are generally secured to a skid (or some type of support platform) via studded blocks and crosses. The studded blocks and crosses connected by spacer spools. Spacer spools are included for accessing the studded blocks and/or the studded crosses. The junctions of the studded blocks and crosses with the spacer spools requires sealing elements. These sealing elements can wear out and require replacement. To access the sealing elements, multiple blocks and crosses have to be unsecured from the skid. The time it takes to unsecure the multiple studded blocks and crosses can be significant and lead to long downtimes for oil and gas well operations.

Accordingly, there is a need for a system that can facilitate access to the sealing elements and require less time to replace the sealing elements.

### SUMMARY OF THE INVENTION

The present disclosure is directed to a frac manifold support system. The system including a platform having a slider plate disposed thereon. The system also including a secure container unit secured relative to the slider plate for supporting a studded cross or studded block. The system further includes a selectively secure container unit slidably disposed on the slider plate for supporting a studded cross or studded block and a driving device for moving the selectively secure container unit towards and away from the secure container unit

The present disclosure is also directed to a method for accessing various parts of a frac manifold via a frac manifold support system. The method includes the step of unsecuring a spacer spool from a studded block or studded cross to gain access to a desired area for maintenance. The method also includes the step of creating a first section of the frac manifold support system and a second section of the frac manifold support system. The first section of the frac manifold support system being the secure container unit, any spacer spools, and any studded blocks or crosses securely supported by the secure container unit. The second section of the frac manifold support system being the selectively secure container unit, any spacer spools, and any studded blocks or crosses securely supported by the selectively secure container unit. Further, the method includes the step of separating the second section of the frac manifold support system from the first section of the frac manifold support system to allow access to the desired area.

### BRIEF DESCRIPTION OF THE DRAWINGS

FIG. 1 is a perspective view of a frac manifold support system constructed in accordance with the present disclosure.

FIG. 2A is a perspective view of a portion of the frac manifold support system constructed in accordance with the present disclosure.

FIG. 2B is a perspective view of another view of the portion of the frac manifold support system shown in FIG. 2A constructed in accordance with the present disclosure.

FIG. 3 is a perspective view of a secure container unit of the frac manifold support system constructed in accordance with the present disclosure.

FIG. 4 is a perspective view of a mobile container unit of the frac manifold support system constructed in accordance with the present disclosure.

FIG. 5A is a perspective view of a selectively secure container unit of the frac manifold support system constructed in accordance with the present disclosure.

FIG. 5B is a cross-sectional view of the selectively secure container unit of the frac manifold support system shown in FIG. 5A constructed in accordance with the present disclosure.

FIG. 5C is a front elevation view of the selectively secure container unit of the frac manifold support system shown in FIG. 5A constructed in accordance with the present disclosure.

FIG. 6 is close-up view of a portion of the frac manifold support system shown in FIG. 2B constructed in accordance with the present disclosure.

FIG. 7A is a side elevation view of the frac manifold support system in an operational setup constructed in accordance with the present disclosure.

FIG. 7B is a side elevation view of the frac manifold support system in a maintenance setup constructed in accordance with the present disclosure.

### DETAILED DESCRIPTION OF THE DISCLOSURE

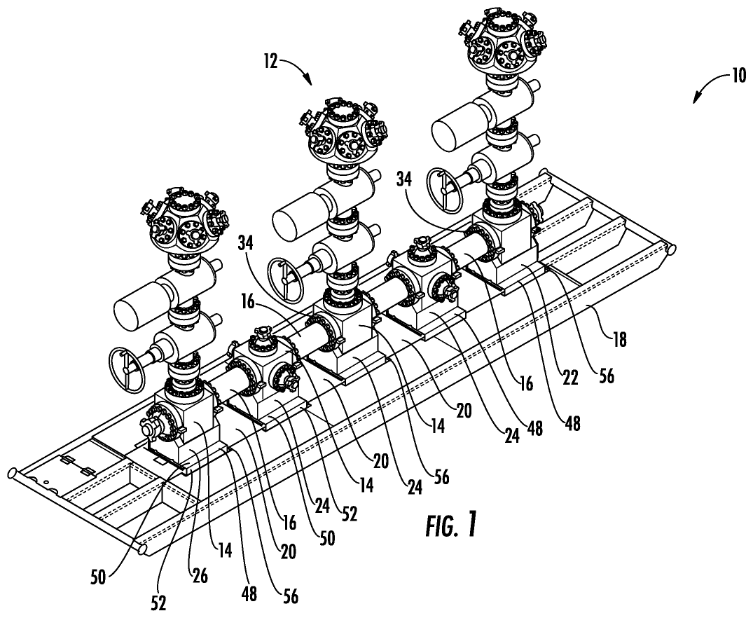

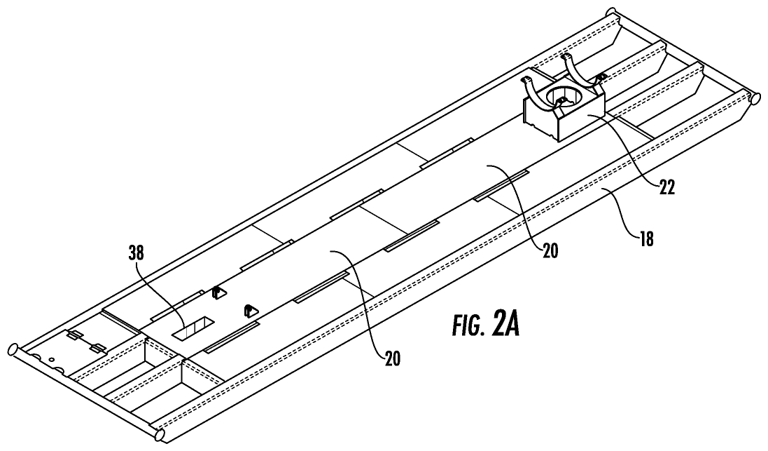

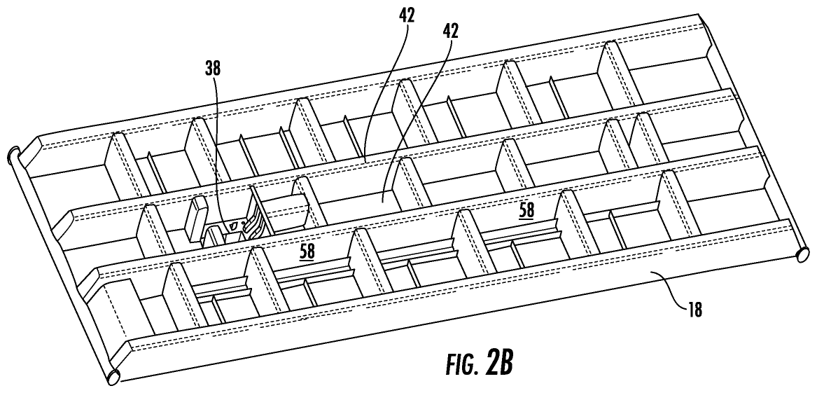

Referring now to FIGS. 1-2B, the present disclosure relates to a frac manifold support system 10 for permitting more efficient access to various parts of a frac manifold 12. A typical frac manifold 12 can have one or more studded crosses 14 or studded blocks 14 that are connected by spacer spools 16. Spacer spools 16 are securely attached on each end to the studded crosses 14 or studded blocks 14. The junction between each end of the spacer spools 16 and the studded crosses 14 or studded blocks 14 typically requires various maintenance to be conducted thereon.

The frac manifold support system 10 includes a platform 18 for supporting and facilitating transportation of the frac manifold 12. The frac manifold support system 10 includes a slider plate 20 disposed on the platform 18 for facilitating easy movement of the studded crosses 14 or studded blocks 14 of the frac manifold 12. The frac manifold support system 10 includes at least one secure container unit 22 securely attachable to the slider plate 20 or some other part of the platform 18 for holding a studded cross 14 or a studded block 14 static with respect to the platform 18 or slider plate 20. The frac manifold support system 10 further includes at least one mobile container unit 24 slidably disposed on the slider plate 20 of the frac manifold support system 10 for holding a studded cross 14 or studded block 14. The frac manifold support system 10 can also include a selectively secure container unit 26 that can be securable relative to the slider plate 20 and slidable on the slider plate 20. The selectively secure container unit 26 is also configured to hold a studded cross 14 or a studded block 14.

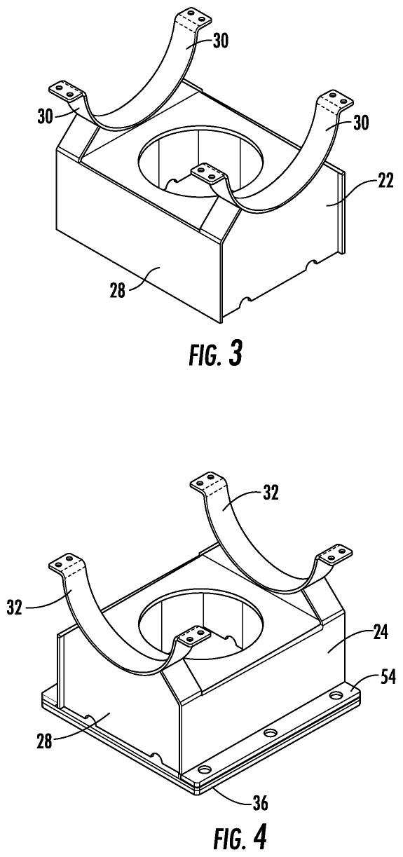

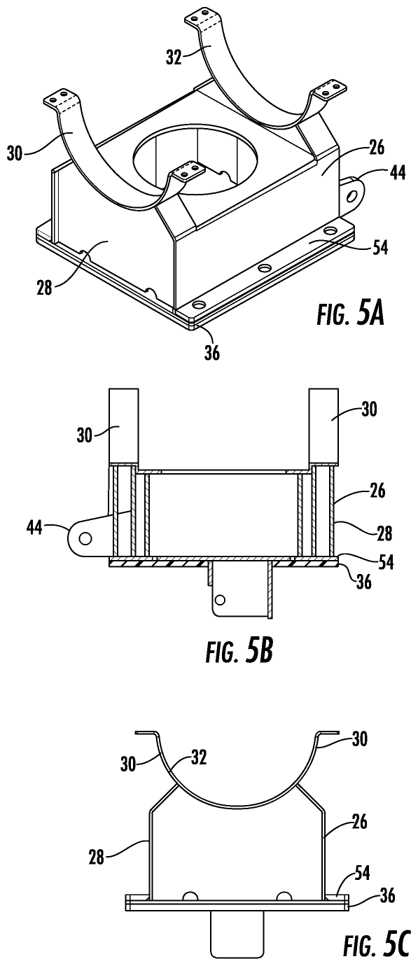

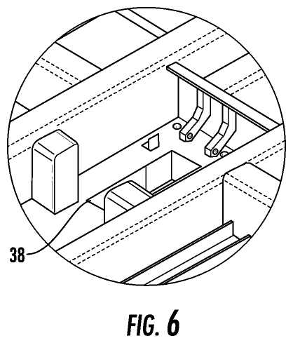

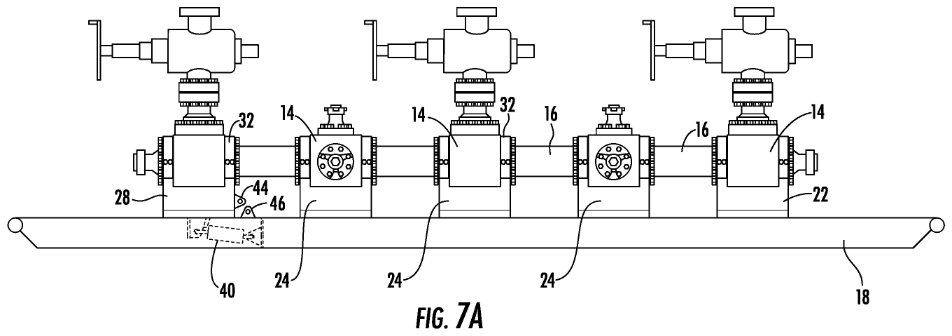

Referring now to FIGS. 3A-6, each container unit 22, 24 or 26 (secure, mobile and selectively secure) is configured to secure the studded cross 14 or the studded block 14 thereto by at least containing a portion of the studded cross 14 or studded block 14. Each container unit 22, 24 or 26 can include a base portion 28 for supporting the studded blocks 14 or crosses 14 and securing portions 30 for securing the studded blocks 14 or crosses 14 to the container unit 22, 24 or 26. In one embodiment, the securing portions 30 of the container unit 22, 24 or 26 can be opposing arched slats 32 that can be secured together around flanges 34 that extend from the studded crosses 14 or studded blocks 14.

The secure container unit 22 can be secured to the slider plate 20 or the platform 18 via any means known to one of ordinary skill in the art. Examples of securing means include, but are not limited to, bolted, welded, or the like. The selectively secure container unit 26 and the mobile container unit 24 further include a slide layer 36 disposed between the slider plate 20 of the frac manifold support system 10 and the base portion 28 to allow the selectively secure container unit 26 and the mobile container unit 24 to be able to slide on the slider plate 20.

The slider plate 20 and the platform 18 of the frac manifold support system 10 include slider openings 38 or slots disposed therein to permit a driving device 40 to engage the selectively secure container unit 26 to be able to slide the selectively secure container unit 26 on the slider plate 20. The driving device 40 can be secured to a bottom side 42 of the platform 18 of the frac manifold support system 10 and push or pull the selectively secure container unit 26. The selectively secure container unit 26 is connected to the mobile container units 24 included in the frac manifold 12 via the appropriate number of spacer spools 16, thus when the selectively secure container unit 26 is pushed or pulled by the driving device 40, the mobile container units 24 can be pushed and pulled as well. The selectively secure container unit 26 can also include ring portions 44 attached thereto to be alignable with ring portions 46 disposed on the platform 18 or slider plate 20 of the frac manifold support system 10. The ring portions 44 of the selectively secure container unit 26 and the ring portions 46 attached to the slider plate 20 or the platform 18 can be pinned together to prevent movement of the selectively secure container unit 26.

The frac manifold support system 10 can be in an operational setup for when the frac manifold 12 is being used for fracturing operations and the frac manifold support system 10 can be in a maintenance setup when work needs to be performed on parts of the frac manifold 12. When the frac manifold support system 10 is in the operational setup, the mobile container units 24 and the selectively secure container units 26 are immovable relative to the slider plate 20 and platform 18 in the direction the container units 24 or 26 run on the slider plate 20, laterally to the direction the container units 24 or 26 run on the slider plate 20 and in a direction upward (or away) from the slider plate 20. Preventing movement of the mobile container units 24 and the selectively secure container units 26 in the direction the container units 24 or 26 run on the slider plate 20 is done by securing the studded blocks 14 and studded crosses 14 in the mobile container units 24 and the selectively secure container unit 26 to the studded cross 14 or studded block 14 supported by the secure container unit 26 via secure connection to the appropriate number of spacer spools 16. Additional securing in this direction is to pin the ring portions 44 attached to the selectively secure container unit 26 to the ring portions 46 attached to the slider plate 20 or the platform 18.

Angled plates 48 can be used to prevent movement of the mobile container units 24 and the selectively secure container units 26 in the direction lateral to the direction the container units 24 or 26 run on the slider plate 20. The angled plates 48 include a first slat portion 50 on one side of the angle and a second slat portion 52 on the other side of the angle. The first slat portion 50 of the angled plate 48 is disposed above the slide layer 36 or a connection plate 54 of the mobile container units 24 and the selectively secure container units 26 to prevent the mobile container units 24 and the selectively secure container units 26 from moving upward from the slider plate 20. The connection plate 54 of the mobile container units 24 and the selectively secure container units 26 is disposed between the base portion 28 and the slide layer 36 of each of the mobile container units 24 and the selectively secure container units 26.

The second slat portion 52 of the angled plate 48 can be attached to the platform 18 to secure the angled plate 48 in place. In one embodiment, the second slat portion 52 of the angled plate 48 can extend through slits 56 in the platform 18 and be secured to an under side portion 58 of the platform 18.

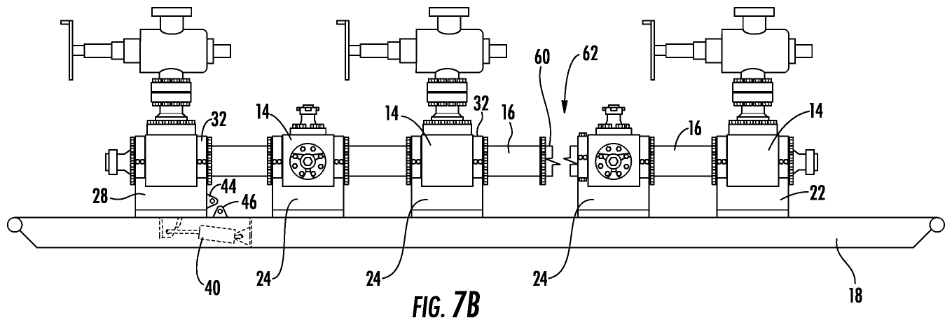

In one embodiment shown in FIGS. 7A and 7B, the secure container unit 22 is the first container unit supporting the studded cross or block 14 in the series of studded crosses 14 and studded blocks 14 of the frac manifold 12 and the selectively secure container unit 26 that supports the last studded cross or block 14 in the frac manifold 12. In this embodiment, the frac manifold 12 is put into the maintenance setup, bolts associated with a desired junction 62 between the studded blocks 14 or studded crosses 14 and the desired end 60 of the desired spacer spool 16 can be removed and the driving device 40 can engage the selectively secure container unit 26 to slide the selectively secure container unit 26 and the mobile container units 24 on the selectively secure container unit-side of the desired junction 62 to expose internal parts of the desired junction 62. Once the internal parts, such as sealing elements, of the desired junction 62 are repaired or replaced, the driving device 40 forces the mobile container units 24 and the selectively secure container unit 26 back towards the secure container unit 22, thus closing the desired junction 62. The bolts can then be replaced, the selectively secure container unit 26 can be resecured relative to the platform 18 or slider plate 20, and the frac manifold 12 can then be placed back into the operational setup.

In another embodiment, the frac manifold support system 10 can include two selectively secure container units 26 disposed on each end of the frac manifold 12, multiple mobile container units 24 disposed between the selectively secure container units 26, and a secure container unit 22 disposed between the selectively secure container units 26. In this embodiment, the frac manifold support system 10 includes more than one driving device 40 to force the mobile container units 24 and the selectively secure container units 26 away from and toward the secure container unit 22. One of the driving devices 40 is used to force the mobile container units 24 and the selectively secure container unit 26 on one side of the secure container unit 22 towards and away from the secure container unit 22, depending on whether the frac manifold 12 is moving to or from the maintenance setup or the operational setup. Another driving device 40 is used to force the remaining mobile container units 24 and the other selectively secure container unit 26 positioned on the other side of the secure container unit 22 toward or away from the secure container unit 22, depending on whether the frac manifold 12 is moving to or from the maintenance setup or the operational setup.

In yet another embodiment, the frac manifold support system 10 can have a selectively secure container unit 26 disposed on each end of the frac manifold 12, multiple mobile container units 24 disposed between the two selectively secure container units 26, and more than one driving device 40 for forcing one of the selectively secure container units 26 (and accompanying equipment) away from the other selectively secure container units 26. In a further embodiment, every container unit in the frac manifold support system 10 can be a selectively secure container unit 26 and various driving forces 40 can be used to push or pull selected selectively secure container units 26 in whatever direction is desirable.

From the above description, it is clear that the present disclosure is well adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A frac manifold support system, the system comprising:
a platform having a slider plate disposed thereon;
a secure container unit secured relative to the slider plate for supporting a studded cross or studded block;
a selectively secure container unit slidably disposed on the slider plate for supporting a studded cross or studded block; and
a driving device for moving the selectively secure container unit towards and away from the secure container unit.

2. The frac manifold support system of claim 1 further comprising a mobile container unit slidably disposed on the slider plate between the selectively secure container unit and the secure container unit.

3. The frac manifold support system of claim 2 wherein the container units are separated by spacer spools.

4. The frac manifold support system of claim 2 wherein the secure container unit, the selectively secure container unit and the mobile container unit include a base portion for supporting the studded blocks or crosses and securing portions for securing the studded blocks or crosses in the secure container unit, the selectively secure container unit and the mobile container unit.

5. The frac manifold support system of claim 4 wherein securing portions of the secure container unit, the selectively secure container unit and the mobile container unit include arched slats that are secured together around flanges that extend from the studded blocks or crosses.

6. The frac manifold support system of claim 4 wherein the selectively secure container unit and the mobile container unit include a slide layer disposed beneath the base portion to engage and slide on the slider plate.

7. The frac manifold support system of claim 6 wherein the selectively secure container unit and the mobile container unit include a connection plate disposed between the base portion and the slide layer.

8. The frac manifold support system of claim 7 further comprising an angled plate to be secured to the platform or slider plate on one end and positioned in close proximity to the connection plate on another end of the angled plate to prevent movement of the secure container unit, the selectively secure container unit and the mobile container unit in a direction away from the slider plate.

9. The frac manifold support system of claim 8 wherein the platform has slots therein for the angled plates to extend through.

10. A method for accessing various parts of a frac manifold via a frac manifold support system, the method comprising:
unsecuring a spacer spool from a studded block or studded cross to gain access to a desired area for maintenance;
creating a first section of the frac manifold support system and a second section of the frac manifold support system, the first section of the frac manifold support system being the secure container unit, any spacer spools, and any studded blocks or crosses securely supported by the secure container unit, the second section of the frac manifold support system being the selectively secure container unit, any spacer spools, and any studded blocks or crosses securely supported by the selectively secure container unit; and
separating the second section of the frac manifold support system from the first section of the frac manifold support system to allow access to the desired area.

11. The method of claim 10 further comprising performing desired maintenance on the frac manifold.

12. The method of claim 10 further comprising positioning the second section of the frac manifold support system adjacent to the first section of the frac manifold support system to allow the second section of the frac manifold support system and the first section of the frac manifold support system to be secured together again.

13. The method of claim 12 further comprising securing the the spacer spool to the studded block or studded cross at the desired area where maintenance was required.

14. The method of claim 10 wherein the frac manifold support system comprises:
a platform having a slider plate disposed thereon;
a secure container unit secured relative to the slider plate for supporting a studded cross or studded block; and
a selectively secure container unit slidably disposed on the slider plate for supporting a studded cross or studded block; and
a driving device for moving the selectively secure container unit towards and away from the secure container unit.

15. The method of claim 14 further comprising a mobile container unit slidably disposed on the slider plate between the selectively secure container unit and the secure container unit.

16. The method of claim 15 wherein the secure container unit, the selectively secure container unit and the mobile container unit include a base portion for supporting the studded blocks or crosses and securing portions for securing the studded blocks or crosses in the secure container unit, the selectively secure container unit and the mobile container unit.

17. The method of claim 16 wherein securing portions of the secure container unit, the selectively secure container unit and the mobile container unit include arched slats that are secured together around flanges that extend from the studded blocks or crosses.

18. The method of claim 16 wherein the selectively secure container unit and the mobile container unit include a slide layer disposed beneath the base portion to engage and slide on the slider plate.

19. The method of claim 18 wherein the selectively secure container unit and the mobile container unit include a connection plate disposed between the base portion and the slide layer.

20. The method of claim 19 further comprising an angled plate to be secured to the platform or slider plate on one end and positioned in close proximity to the connection plate on another end of the angled plate to prevent movement of the secure container unit, the selectively secure container unit and the mobile container unit in a direction away from the slider plate.
